(19) United States
(12) Patent Application Publication
(10) Pub. No.: US 2015/0116989 A1
(43) Pub. Date: Apr. 30, 2015

(54) Lighted Lacrosse Stick Handle

(71) Applicant: Kevin J. McFalls, Glen Arm, MD (US)

(72) Inventor: Kevin J. McFalls, Glen Arm, MD (US)

(21) Appl. No.: 14/066,816

(22) Filed: Oct. 30, 2013

(51) Int. Cl. F21V 33/00; A63B 59/02

(52) U.S. Cl. CPC F21V 33/008; A63B 59/02
USPC 362/109

(57) ABSTRACT

An illuminated handle for a lacrosse or other sport/recreational stick includes: (1) an elongated, cylindrical member, (2) an axial aligned bore located in one of the ends of this member, (3) a light source having an illumination surface which is configured to allow it to be mounted flush against the bore's bottom surface, (4) wherein this member is fabricated from a translucent plastic material, (5) wherein the bore's bottom surface is configured to maximize the amount of light that is transmitted between the member's ends, and (6) wherein the member's outer surface is configured to maximize the amount of light that is transmitted through it.

### SUMMARY OF THE INVENTION

Recognizing the need for the development of an illuminated handle for a lacrosse stick, the present invention is generally directed to satisfying this need. In accordance with a preferred embodiment of the present invention, an illuminated handle for a lacrosse or other sports or recreational stick includes: (1) an elongated, solid cylindrical member, (2) an axial aligned bore located in one of the ends of this member, (3) a light source having an illumination surface and a configuration adapted to allow this illumination surface to be mounted flush against the bore's bottom surface, (4) wherein the bore's diameter is sufficiently less than that of the member so as to maintain the structural strength of the member in the area of the bore, (5) wherein the elongated member's material of construction is a translucent plastic material, (6) wherein the bore's bottom surface is configured to maximize the amount of light that is transmitted through the bore's bottom surface and between its ends, and (7) wherein the member's outer surface is configured to maximize the amount of light that is transmitted through it.

A first variant of this preferred embodiment is achieved when the member's non-bore-containing end has a surface that is configured to make light reflect from it.

A second variant of this preferred embodiment is achieved when the handle's light source is configured so as to provide illumination in any one of a plurality of colors.

A third variant of this preferred embodiment is achieved when the handle's translucent plastic material is acrylic and the light source is further configured to provide a measure of light in the range of 8-16 lumens/inches³ of illuminated handle volume.

A fourth variant of this preferred embodiment is achieved when it further includes an instrumentation array configured to identify and produce a control signal when a ball is located in a basket or head that is attached to an end of this member.

A fifth variant of this preferred embodiment is achieved when it further includes a light source control system that is configured to utilize this instrumentation control signal so as to cause the color of the illumination of the light source to change when a ball is located in such a stick's basket.

Thus, there has been summarized above (rather broadly and understanding that there are other preferred embodiments which have not been summarized above) the present invention in order that the detailed description that follows may be better understood and appreciated.

### BRIEF DESCRIPTION OF THE DRAWINGS

FIG. 1 is a perspective view of a prior art lacrosse stick.

FIG. 2 is a perspective view of a lacrosse stick handle in accordance with a preferred embodiment of the present invention.

FIG. 3 is an axial sectional view taken along lines 3-3 of the handle of the present invention shown in FIG. 2

FIG. 4 is a cross sectional view taken near the distal end of the handle of the present invention shown in FIG. 2

FIG. 5 shows an instrumented head that is appropriate for use with the present invention.

### DESCRIPTION OF THE PREFERRED EMBODIMENT

Before explaining at least one embodiment of the present invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

For example, we speak herein of a lacrosse stick as being comprised of a handle, shaft or pole that has mounted on its end a head or basket. Meanwhile, it is quite common in lacrosse terminology to use the words lacrosse stick, handle, shaft or pole interchangeably. Thus to avoid the confusion that can be created by using such interchangeable words, we will try herein to stick to our terminology of a lacrosse stick as having a handle, shaft or pole to which is attached a head or basket.

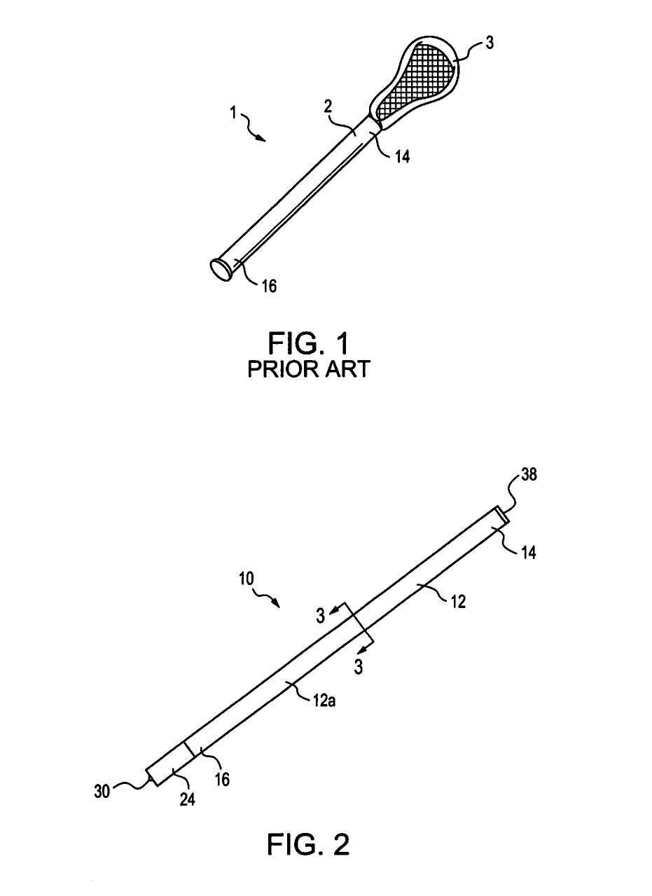

Referring to FIG. 1, there is illustrated a preferred embodiment of a prior art lacrosse stick 1 in which one can see this stick's handle 2 and its attached head or basket 3. A similar head would be attached to the illuminated lacrosse stick handle or shaft 10 of the present invention which is shown in FIG. 2.

It is seen to include an elongated, solid, cylindrical member 12 or handle/shaft that has a proximal end 14 which is, among other things, adapted to be attached to a lacrosse head. This handle 12 does not take the form of a traditional lacrosse stick—i.e., a hollow tubular member fabricated from a light-weight metal alloy, such as aluminum or titanium. Instead, the handle of the present invention is fabricated from a translucent material, such as clear acrylic. To increase light transmission from it, its outer surfaces 12a has a configuration adapted to maximize the amount of light that is transmitted through it; for example, it can be polished to achieve such results.

Because of the density differences between wood, aluminum or titanium and acrylic (density ratios of wood, aluminum or titanium to acrylic are approximately 0.7, ˜2.3 and ˜3.8, respectively) and that fact that the handle of the present invention is solid rather than tubular, the weight of this handle when made from solid acrylic is comparable to that of the classic, solid wooden handle. Meanwhile, physical stress testing of the acrylic handle revealed that it could withstand the expected loads that would be placed upon it during a typical lacrosse game.

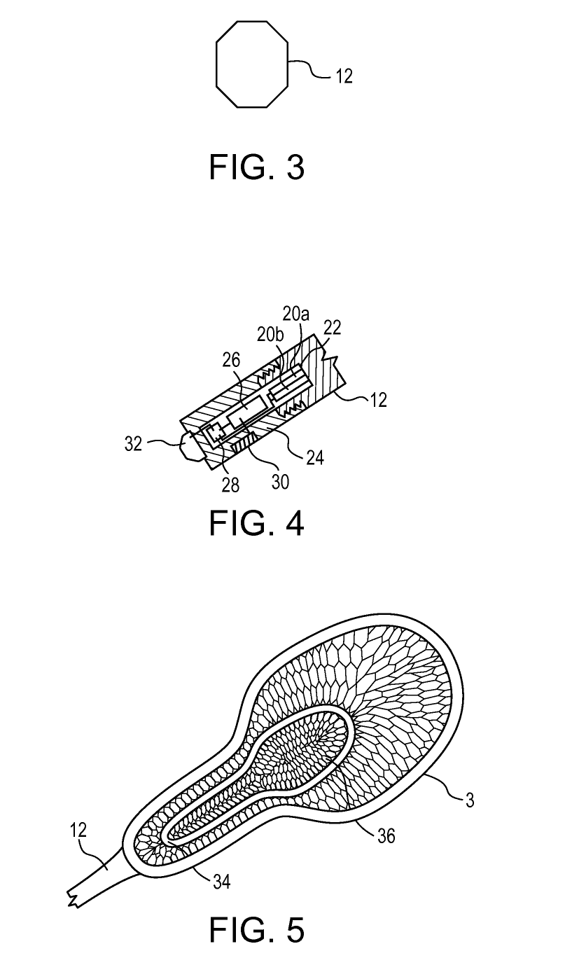

FIG. 3 is an axial sectional view taken along lines 3-3 of the handle of the present invention that is shown in FIG. 2. This cylindrical member is seen to have a polygonal (e.g., octagonal) shape as dictated by the requirement to try to give a lacrosse player who is wearing gloves more feel for and therefore more control of the stick. The cross-sectional dimensions of this acrylic handle are comparable to those for the traditional hollow aluminum or titanium lacrosse sticks.

An axial bore 18 in drilled into the distal 16 end of this cylindrical member 12 and is provided with dimensions (e.g., diameter=0.25 inches, or a range of 0.2-0.4 inches) and a configuration that is adapted to allow it to serve as a reservoir where the handle's light source 20 is to be mounted. See FIG. 4. This bore is provided with a flat polished bottom surface 22 in order to increase or maximize the amount of light that is transmitted through the bore's bottom surface and along the handle's axial centerline and throughout its length. Meanwhile, to further enhance light transmission though the handle, the front face or illumination surface of this light source is mounted flush against the bore's bottom surface 22.

As shown in FIG. 4, the distal end of the handle has a removable butt 24 or end cap that can be removed to allow access to the present invention's light source 20, rechargeable battery 26 and a circuit board 28 that has been engineered to control the operation of the light source.

The depth of the handle's bore and its diameter are sufficient so as to accommodate the location of the light source within the bore, while at the same time being such that the amount of material removed from an approximately one inch diameter lacrosse handle, in forming this bore and any threads that might be used to join the butt 24 to the handle's distal end, is such that it does not structurally weaken the handle in the area of the bore so as to result in handle breaks or cracks in this area. Preferred bore diameters and depths are in the ranges of 0.3-0.6 inches and 0.5-1.0 inches, respectively.

A cylindrical light source 20 is utilized that has a configuration adapted to allow it to fit within the bore while providing sufficient illumination along the handle's length. Its power source or rechargeable battery 26 may also be located in the bore and behind the light source, but is normally contained in the handle's butt, which is also where the invention's printed circuit board can be located. A USB or other suitable port 30 is located in the butt so as to provide a power link to the rechargeable battery. Also included proximate to this distal end, typically also in the handle's butt 24, is a switch 32 that controls the power source and certain functioning of the circuit board.

The amount of light necessary to adequately illuminate the total length of the handle of an attackman's stick that is approximately 40 inches in length, or in the range of 38 to 44 inches, long and one inch diameter stick is in the range of 300-500 lumens. In terms of the volume of such handles, this equates to a luminosity requirement in the range of 8-16 lumens/inches³ of illuminated handle volume. Such an illumination is seen to adequate to cover the full range of lacrosse stick lengths, from fiddle sticks with lengths in the range of 35-40 inches to defenseman's sticks whose lengths are in the range of 50-75 inches. Numerous light sources of various lamination strengths are available for this task and all are considered to come within the scope of the present invention—for example, a 6-7 watt, white LED, a 600 milliwatt green laser, or a 40 watt incandescent lamp. A key consideration in the selection of an appropriate light source is the requirement that it must withstand the stresses that are placed upon the handle when it is being used to play lacrosse.

In many instances, it may be desirable to provide this handle with the capability to be illuminated at different times by different colors. For a first example, a different color could be used to help identify during a game the particular lacrosse player's stick whose basket currently contains the ball (i.e., with the stick's handle changing from its normal green color to the color red when the ball is in the stick's basket and then returning to green when the ball has been passed or shot at goal). For a second example, the members of opposing teams could further distinguish themselves by using different colored handles (i.e., the members of one team use a first color for their handles, while the members of the other team use a second color for their handles). This color-changing capability is accomplished by placing various, colored light sources in the handle's bore 18 and configuring the handle's switch 32 and circuit board 28 so they can control the operation of these alternative light sources.

As an alternative to using the previously mentioned switch, this switching function can, in certain instances, be performed by providing the handle and head with instrumentation that has been configured to measure or identify and produce a control signal when a lacrosse ball is in the head of this stick. For example, an instrumentation array with appropriate transducers 34 can be located in the stick's head and configured in such a manner so as to distinguish when a ball is located in the stick's head or basket and generate an electrical signal which is transmitted to the circuit board or a lighting control system which has been configured to cause the color of the handle's lightening to change to an agreed upon color, e.g., a normally white lighted handle turns to green for the period in which the ball is in the basket and returns to white colored lighting when the ball leaves the basket, so as to identify that this stick's basket is the current location of the ball. This is a key piece of information for lacrosse players to have when they are using such illuminated sticks to play in conditions of low visibility and it would otherwise be difficult to follow a ball's movements without such color-coded, identifying illumination.

Shown in FIG. 5 is an example of such an instrumentation array in which a special piece of webbing 36 has been added around the pocket of the basket and outfitted with strain gauges which measure the additional forces imposed on the piece of webbing when a lacrosse ball is located in such a stick's head. A wireless transmitter, which is also in the head, relays the transducer readouts to a receiver in the butt of the handle.

To further increase the illumination of the handle, a reflective cap or mirror 38 is affixed to the handle's proximal end 14. A preferred manner of providing such a cap is to fabricate it as a acrylic disc in which the disc's side that comes into contact with the proximal end is provided with a mirror finish.

In addition to making night-time playing of lacrosse a step closer to a reality, the handle of the present invention, with a few obvious additional elements, can be used for a number of other purposes. For example, the previously mentioned, colored lights and remote controls can be used to flash different colors upon the scoring of a goal by a player using an illuminated stick as a means to rally the goal scorer's teammates and fans. “Novelty (i.e., less expensive, not-engineered-for-play)” versions of these sticks could be used by cheerleaders and fans to flash at selected times (e.g., during the appropriate part of a cheer) in further support of the play of a team outfitted with the playable versions of such illuminated sticks.

While the above discussion has been directed towards a lacrosse handle, it should be realized that the present invention can easily be modified so as to be application to a wide range of sports or everyday uses. For example, alternative versions of the present invention can be used for the handles of sticks that are used in other sports (e.g., hockey, tennis, skiing (i.e., ski pole)) or routine daily activities (e.g., as the handle for a walking stick).

In addition to providing a handle with the capability to be illuminated at different times by different colors, there are other instances when sticks or handles may be needed than don't change colors with time, but which permanently take on different colors. Such permanent-colored handles may be fabricated by utilizing various colored, acrylic materials. When such colored, acrylic sticks are to be used only outside during daylight hours when there is sufficient ambient lighting, it may not be necessary to fit them with their own illumination systems—indeed, there would appear to be a market for lacrosse sticks having colored acrylic handles.

The foregoing is considered as illustrative only of the principles of the invention. Further, since numerous modifications and changes will readily occur to those skilled in the art, it is not desired to limit the invention to the exact construction and operation shown and described herein. Accordingly, all suitable modifications and equivalents may be resorted to, falling within the scope of the invention that is hereinafter set forth in the claims to the invention.

1. An illuminated handle comprising:
an elongated, solid cylindrical member having proximal and distal ends with an axis therebetween, a specified member diameter and an outer surface,
an axial aligned bore in one of said member ends, said bore having a bore bottom surface and a specified bore depth and bore diameter,
wherein said bore diameter is sufficiently less than that said member diameter and said bore depth is chosen so as to maintain the structural strength of said member in the area of said bore,
a light source having an illumination surface and a configuration adapted to allow said illumination surface to be mounted flush against said bore bottom surface,
wherein the material of construction of said elongated member is a translucent plastic material,
wherein said bore bottom surface having a configuration adapted to maximize the amount of light from said light source that is transmitted through said bore bottom surface and between said member ends, and
wherein said entire outer surface of said cylindrical member being flat and polished to maximize the amount of light from said light source that is transmitted through said member outer surface.

2. The illuminated handle as recited in claim 1, wherein:
said member end that is opposite to that end containing said bore having an end surface which has a configuration adapted to make said end surface reflect the light received from said light source so as to increase the illumination coming from said handle.

3. The illuminated handle as recited in claim 1, wherein:
said light source has a configuration which enables said light source to provide illumination to said member in any one of a plurality of colors.

4. The illuminated handle as recited in claim 2, wherein:
said light source has a configuration which enables said light source to provide illumination to said member in any one of a plurality of colors.

5. The illuminated handle as recited in claim 1, wherein:
said translucent plastic material is acrylic,
said light source is further configured to provide a measure of light in the range of 8-16 lumens/inches³ of illuminated handle volume.

6. The illuminated handle as recited in claim 2, wherein:
said translucent plastic material is acrylic,
said light source is further configured to provide a measure of light in the range of 8-16 lumens/inches³ of illuminated handle volume.

7. The illuminated handle as recited in claim 3, wherein:
said translucent plastic material is acrylic,
said light source is further configured to provide a measure of light in the range of 8-16 lumens/inches³ of illuminated handle volume.

8. The illuminated handle as recited in claim 4, wherein:
said translucent plastic material is acrylic,
said light source is further configured to provide a measure of light in the range of 8-16 lumens/inches³ of illuminated handle volume.

9. The illuminated handle as recited in claim 3, said handle further comprising:
a transducer having a configuration adapted to identify and produce a control signal when a ball is located in a head attached to the proximal end of said member.

10. The illuminated handle as recited in claim 4, said handle further comprising:
a transducer having a configuration adapted to identify and produce a control signal when a ball is located in a head attached to the proximal end of said member.

11. The illuminated handle as recited in claim 5, said handle further comprising:
a transducer having a configuration adapted to identify and produce a control signal when a ball is located in a head attached to the proximal end of said member.

12. The illuminated handle as recited in claim 6, said handle further comprising:
a transducer having a configuration adapted to identify and produce a control signal when a ball is located in a head attached to the proximal end of said member.

13. The illuminated handle as recited in claim 7, said handle further comprising:
a transducer having a configuration adapted to identify and produce a control signal when a ball is located in a head attached to the proximal end of said member.

14. The illuminated handle as recited in claim 8, said handle further comprising:
a transducer having a configuration adapted to identify and produce a control signal when a ball is located in a head attached to the proximal end of said member.

15. The illuminated handle as recited in claim 9, said handle further comprising:
a light source control system which has a configuration that utilizes said transducer control signal so as to cause the color of the illumination of said light source to change when a ball is located in said head attached to the proximal end of said member.

16. The illuminated handle as recited in claim 10, said handle further comprising:
a light source control system which has a configuration that utilizes said transducer control signal so as to cause the color of the illumination of said light source to change when a ball is located in said head attached to the proximal end of said member.

17. The illuminated handle as recited in claim 11, said handle further comprising:
a light source control system which has a configuration that utilizes said transducer control signal so as to cause the color of the illumination of said light source to change when a ball is located in said head attached to the proximal end of said member.

18. The illuminated handle as recited in claim 12, said handle further comprising:
a light source control system which has a configuration that utilizes said transducer control signal so as to cause the color of the illumination of said light source to change when a ball is located in said head attached to the proximal end of said member.

19. The illuminated handle as recited in claim 13, said handle further comprising:
a light source control system which has a configuration that utilizes said transducer control signal so as to cause the color of the illumination of said light source to change when a ball is located in said head attached to the proximal end of said member.

20. The illuminated handle as recited in claim 14, said handle further comprising:
a light source control system which has a configuration that utilizes said transducer control signal so as to cause the color of the illumination of said light source to change when a ball is located in said head attached to the proximal end of said member.
